(19) United States
(12) Patent Application Publication
(10) Pub. No.: US 2019/0098921 A1
(43) Pub. Date: Apr. 4, 2019

(54) METHOD FOR MANUFACTURING INSTANT FOOD CAPABLE OF BEING INDUCTIVELY COOKED, METHOD FOR COOKING INSTANT FOOD, AND DEVICE FOR HEATING AND COOKING INSTANT FOOD

(71) Applicant: Bocal Co. LTD., Suwon-si (KR)

(72) Inventors: Han PARK, Ansan-si (KR); Hwan Suk CHO, Seoul (KR); Young Sook BAEK, Ansan-si (KR)

(73) Assignee: Bocal Co. LTD., Suwon-si (KR)

(21) Appl. No.: 16/085,631

(22) PCT Filed: Feb. 1, 2017
(86) PCT No.: PCT/KR2017/001056

§ 371 Date: Sep. 17, 2018

(30) Foreign Application Priority Data
Mar. 18, 2016 (KR) 10-2016-0032480
Jan. 5, 2017 (KR) 10-2017-0001910

(51) Int. Cl. A23L 23/10; A23L 3/36; A23L 5/10; A23L 13/40; A23L 17/30; A23L 33/135

(52) U.S. Cl. CPC A23L 23/10; A23L 3/36; A23L 5/13; A23Y 2220/00; A23L 13/424; A23L 17/30; A23L 33/135; A23L 5/15

(57) ABSTRACT

The present invention relates to a method for manufacturing instant food capable of being inductively cooked, a method for cooking the instant food, and a device for heating and cooking the instant food and, more specifically, the manufacturing method comprises: a soup forming step of making an instant food soup into a plate-shaped soup formation; a solid ingredient stacking step of putting the soup formation made through the soup making step into an instant food cooking container, and stacking instant food solid ingredients thereon; and a packaging step of sealing, by a cover, the open mouth of the instant food cooking container in which the solid ingredients are accommodated in a state of being stacked on the soup formation through the solid ingredient stacking step. An instant food manufactured and cooked through the steps can be simply cooked through hot water and an induction device, exhibits a uniform taste, and contains rich nutritional content so as to promote a consumer's health.

### TECHNICAL FIELD

The present invention relates to a method for manufacturing instant food capable of being inductively cooked, a method for cooking the instant food, and a device for heating and cooking the instant food such that instant food can be simply cooked through an induction device, can exhibit a uniform taste, and can be rich in nutrients thereby making it possible to improve a consumer's health.

### DESCRIPTION OF THE RELATED ART

First, the related art that will be described below is provided for a better understanding of the present invention, and the related art should not be defined as a prior art.

In general, the first phase of cooking is performed to instant food, the instant food is packaged, and frozen or refrigerated to be sold, and then the instant food is taken out of a package, and the second phase of cooking is performed to the instant food through a microwave oven, or a heating apparatus using gas or electricity such that a customer eats the instant food.

Conventionally, instant food is simply heated through a heating device such as a microwave oven etc. Thus, such a conventional art does not help retain flavor and nutrients of instant food.

Further, the above-described instant food to which the first phase of cooking is done cannot retain flavor and nutrients of instant food itself because of the second phase of cooking. Thus, the favor and nutrient of instant food are changed thereby making it hard to sell a massive amount of instant food.

However, recently, instant food to which the first phase of cooking is done and which can be eaten immediately like cooked food has been released in the market. In addition, various devices for simply cooking instant food are also available on the market.

Additionally, in recently years, instant food for induction cooking has been released. In terms of the instant food for induction cooking, the first phase of cooking is done to food, and then the food is sealed and packaged in a cooking container etc. into which an induction heating body is built and which consists of paper, synthetic resins or aluminum, and frozen or refrigerated so as to be stored. Such instant food is frozen after the first phase of cooking. Thus, the instant food can be stored for a long time while retaining flavor and nutrients.

Further, South Korean Patent No. 10-1519465 discloses an invention titled “Apparatus for cooking fast food” capable of simply and immediately cooking instant food for induction cooking as a related art of an induction heating type apparatus for cooking fast food.

The above-described invention includes a cool water tank for storing cooking water, a rapid heating stand for instantly heating the cooking water supplied by the cool water tank, a solenoid valve for controlling the amount of supply of the cooking water passing the rapid heating stand, and a tag readable stand for reading tag information attached to an aluminum container and the package of convenient food so as to determine the sort of convenient food by recognizing the tag information, to control an amount of supplied cooking water and a period of time for heating depending on the sort of the convenient food for cooking, to instantly heat and supply the cooking water in place of a separate hot water tank, and to hygienically and safely cook, and provided with a display panel so as to display an advertisement at the time of cooking.

In the case of the related art, a proper amount of water is supplied to a cooking container containing instant food, and then the instant food is inductively cooked. However, while the instant food contained in the cooking container consisting of paper, aluminum or synthetic resins is cooked by an induction device, the lower portion of the instant food, closed to an induction coil part, is intensely heated. Thus, heat is not evenly delivered to the instant food. As a result, the instant food cannot retain fresh flavor that retains after the first phase of cooking.

Further, while the lower portion of the instant food, closed to an induction coil part, is intensely heated, the instant food can be burnt or the nutrients of the instant foods can be damaged or removed.

### DETAILED DESCRIPTION OF THE INVENTION

### Technical Problems

As a means to solve the above-described problems, the present invention relates to a method for manufacturing instant food capable of being inductively cooked, a method for cooking the instant food, and a device for heating and cooking the instant food such that instant food can be simply cooked through an induction device, can exhibit a uniform taste, and can be rich in nutrients thereby making it possible to improve a consumer's health.

### Technical Solutions

The present invention according to a preferred embodiment includes a soup forming step of forming a soup for instant food into a plate-shaped soup formation; a solid ingredient stacking step of putting a soup formation made through the soup forming step into an instant food cooking container and stacking instant food solid ingredients on the soup formation; and a packaging step of sealing, with a cover, the mouth of the instant food cooking container in which the solid ingredients are stacked on the soup formation through the solid ingredient stacking step.

More preferably, a soup for instant food is frozen in a 4-mm to 5-mm-thick plate shape and formed into a soup formation. More preferably, the solid ingredients may be configured to be 5 to 20 mm thick.

More preferably, the soup formation may be configured to further include 1 to 3 parts by weight of lactic acid bacteria, and 3 to 5 parts by weight of roe with respect to 100 parts by weight of a soup formation.

More preferably, the lactic acid bacteria may consist of Lactobacillus sporogenes.

More preferably, the roe may consist of one or more selected from a group consisting of salmon roe, walleye pollock roe, flying fish roe, and herring roe.

The present invention according to a preferred embodiment includes an instant food positioning step of mounting, onto a device for cooking instant food, an instant food cooking container in which a soup formation and solid ingredients are accommodated with a cover on the instant food cooking container, a hot water supplying step of making a hot water nozzle of the device for cooking instant food penetrate the upper surface of the cover of the instant food cooking container mounted onto the device for cooking instant food through the instant food positioning step and of supplying hot water supplied through the hot water nozzle into the instant food cooking container, and an instant food heating step of heating the hot water, supplied into the instant food cooking container through the hot water supplying step, the soup formation and solid ingredients through the device for heating and cooking instant food.

The present invention according to another preferred embodiment, as a device for heating and cooking instant food, which heats and cooks a soup formation and solid ingredients accommodated in an instant food cooking container, and hot water includes a body whose inner space is divided into the front and the rear by a vertical bracket—wherein the space of the front is divided into the upper portion and the lower portion by a horizontal partition plate installed on the front surface of the vertical bracket and configured to horizontally extend, an electric outfitting part where a hot water generating part is installed at the upper portion of the front inside the body, and a cool water storage tank is installed at the rear inside the body, and a cooking part where a second cooking space is formed at the lower portion of the front inside the bod, and an open and closed type induction heating part is provided in the second cooking space.

More preferably, the hot water generating part may include a guide frame installed at the upper surface of the horizontal partition plate, a forward and reverse speed reduction motor installed at the upper surface of the guide frame, a screw member installed and configured to extend downwards from the shaft of the forward and reverse speed reduction motor through a clutch member, an ascending and descending plate coupled to a nut member joining the lower end of the screw member, a hot water nozzle installed at one side of the ascending and descending plate and provided with a sharp part which has discharging holes at the lower end thereof extending vertically downwards, a solenoid valve whose one side connects with the hot water nozzle, whose other side connects with the cool water storage tank, and which connects with a hot water tank generating hot water so as to selectively supply hot water to the hot water nozzle.

More preferably, the clutch member includes a housing in which the upper end of the screw member penetrates and is installed, and a cover coupled to the opened upper surface of the housing, at the center of the lower surface of the housing, wherein the end of the shaft of the forward and reverse speed reduction motor, penetrating the upper surface of the cover, and the upper end of the screw member, penetrating the lower surface of the housing, are connected through a connecting member, a washer, and a plurality of plate sprigs so as to prevent the rotational force of the forward and reverse speed reduction motor from being delivered to the screw member when the forward and reverse speed reduction motor is overloaded.

More preferably, a disk may be installed at the upper side of the clutch member such that the shaft of the forward and reverse speed reduction motor penetrates the center of the clutch member, and a photo sensor may be installed at one side of the disk so as to sense the frequency of the rotation of the disk.

More preferably, the open and closed type induction heating part includes guide rails respectively installed on both sides of the inside of the second cooking space, a shuttling plate slidably coupled to the guide rails so as to come in and out of the second cooking space and having a mounting hole at the center of the upper surface thereof so as to mount an instant food cooking container to a certain depth, an induction cooking stand including a ceramic glass plate installed on the lower side of the mounting hole of the shuttling plate and an induction coil installed at the lower portion of the ceramic glass plate, a plurality of transfer guides installed at the rear surface of the shuttling plate, configured to horizontally extend and configured to have a certain length, a transfer connecting member connecting the ends of the transfer guides, paralleling the rear surface of the shuttling plate and having a guide hole with a long hole shape, a driving motor installed at lower portion of the rear of the inside of the body, a crank member which is parallelly installed on the upper side of the transfer connecting member, whose one end connects with the shaft of the driving motor through the clutch member, and whose other end is link-coupled to the guide hole, and an opening and closing door installed at the front of the second cooking space and configured to open and close the first cooking space according to the forward and backward movement of the shuttling plate.

More preferably, the clutch member includes a housing to which the upper surface of one side of the crank member is fixed so as to cross the center of the lower surface of the housing, and a cover coupled to the opened upper surface of the housing, wherein the end of the shaft of the driving motor, penetrating the upper surface of the cover, and the upper surface of the one side of the crank member, penetrating the lower surface of the housing, are connected through a connecting member, a washer, and a plurality of plate sprigs so as to prevent the rotational force of the driving motor from being delivered to the crank member when the driving motor is overloaded.

### Advantageous Effects

A method for manufacturing instant food capable of being inductively cooked, a method for cooking the instant food, and a device for heating and cooking the instant food according to the present invention is capable of simply and rapidly cooking instant food through a device for heating and cooking instant food, exhibiting a uniform taste, and containing nutrients thereby making it possible to improve a consumer's health.

### BRIEF DESCRIPTION OF THE DRAWINGS

FIG. 1 is a perspective view illustrating a configuration of a device for heating and cooking instant food according to an embodiment of the present invention.

FIG. 2 is another perspective view illustrating a configuration of a device for heating and cooking instant food according to an embodiment of the present invention.

FIG. 3 is yet another perspective view illustrating a configuration of a device for heating and cooking instant food according to an embodiment of the present invention.

FIG. 4 is a perspective view illustrating a main configuration of a device for heating and cooking instant food according to an embodiment of the present invention, seen from the rear.

FIG. 5 is a perspective view illustrating a main configuration of a device for heating and cooking instant food according to an embodiment of the present invention, seen from the front.

FIG. 6 is a perspective view exemplifying a steam generating part and an open and closed type steam heating part of a device for heating and cooking instant food according to an embodiment of the present invention.

FIG. 7 is another perspective view illustrating a steam generating part and an open and closed type steam heating part of a device for heating and cooking instant food according to an embodiment of the present invention.

FIG. 8 is a perspective view exemplifying a hot water generating part and an open and closed type induction heating part of a device for heating and cooking instant food according to an embodiment of the present invention.

FIG. 9 is a perspective view exemplifying a steam generator of a device for heating and cooking instant food according to an embodiment of the present invention.

FIG. 10 is a perspective view illustrating a main portion of a clutch member of a device for heating and cooking instant food according to an embodiment of the present invention.

FIG. 11 is a view illustrating a main configuration of a device for heating and cooking instant food according to an embodiment of the present invention, seen from a lower side.

FIG. 12 is a perspective view illustrating a main portion where a part of an opening and closing door is removed from an open and closed type steam heating part of a device for heating and cooking instant food according to an embodiment of the present invention.

FIG. 13 is another perspective view exemplifying an open and closed type steam heating part of a device for heating and cooking instant food according to an embodiment of the present invention.

FIG. 14 is a perspective view exemplifying a clutch member positioned at an open and closed type steam heating part of a device for heating and cooking instant food according to an embodiment of the present invention.

FIG. 15 is a flow chart illustrating a method for manufacturing instance food capable of being inductively cooked according to an embodiment of the present invention.

FIG. 16 is a flow chart illustrating a method for manufacturing instance food capable of being inductively cooked according to an embodiment of the present invention.

### BEST MODE FOR CARRYING OUT THE INVENTION

The preferred embodiments of the present invention and the physical properties of each ingredient will be described in detail such that those skilled in the art to which the present invention pertains can easily realize the present invention. However, the technical spirit and scope of the present invention is not limited to the embodiments.

During description of the embodiments, the size and shape etc. of elements illustrated in the drawings can be exaggerated for the sake of convenience and clarity in description. Further, the terms defined considering the configurations and functions of the present invention may differ depending on the intention or the practice of the user or operator. Therefore, such terms should be defined on the basis of what is described throughout the specification.

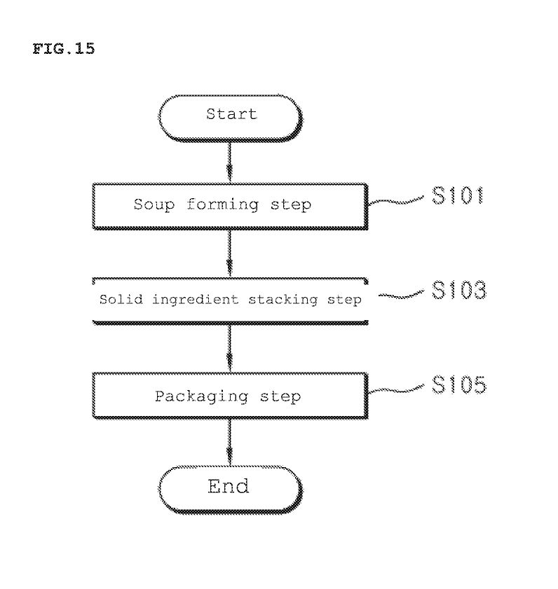

A method for manufacturing instant food according to the present invention, as illustrated in FIG. 15, includes a soup forming step S101 of forming a soup for instant food into a plate-shaped soup formation; a solid ingredient stacking step S103 of putting a soup formation made through the soup forming step S101 into an instant food cooking container and stacking instant food solid ingredients on the soup formation; and a packaging step S105 of covering and sealing, with a cover, the instant food cooking container in which the solid ingredients are stacked through the solid ingredient stacking step S103.

The soup forming step S101 is a step at a soup for instant food is formed into a plate-shaped formation. A soup for instant food is frozen in a 4-mm to 5-mm-thick plate shape and formed into a soup formation. The entire shape of the soup formation may be typically configured to have any shape whose size does not exceed the size of the inner bottom surface of an instant food cooking container. However, the entire shape of the soup formation is preferably configured to have a shape corresponding to the shape of the inner bottom surface of the instant food cooking container such that the outer circumference of a soup formation entirely fills the inner bottom surface of the instant food cooking container.

If the soup formation is less than 4 mm in thickness, the amount of soup of instant food is much less than the amount of supplied water. This makes the instant food less tasty. If the amount of water that is supplied to control the salinity of instant food is reduced, this leads to a reduction in efficiency in heating solid ingredients contained in instant food.

Further, if the soup formation is more than 5 mm in thickness, the amount of the soup formation is much more than the amount of supplied hot water. This leads to an increase in the salinity of instant food. In addition, heat sources generate by an induction device are usually delivered within the range of 25 mm. Considering the thickness of solid ingredients applied to instant food, heat sources of an induction device may not be simultaneously delivered to a soup formation and solid ingredients. Accordingly, it can take a long time to heat instant food.

In this case, the instant food may be applied as a formulation such soups, cold noodles, hot noodles etc. and is preferably configured as a food where soup and solid ingredients are mixed such as seolleongtang (beef bone soup), gomtang (beef bone soup) galbitang (short rib soup), yukgaejang (spicy beef soup), gukbap (hot soup with rice), sundaeguk (blood sausage soup) etc.

Further, the soup formation may further include 1 to 3 parts by weight of lactic acid bacteria, and 3 to 5 parts by weight of roe with respect to 100 parts by weight of a soup formation. If lactic acid bacteria are contained in a soup formation, as described above, rich nutrients may be contained in the soup formation, and the lactic acid bacteria may inhibit the growth of harmful microorganisms in the intestines thereby making it possible to provide instant food that can help to promote users' health.

If the content of lactic acid bacteria in instant food is less than 1 part by weight, the amount does not have a meaningful effect on the inhibition of the growth of harmful microorganisms and promotion of users' health. If the content of lactic acid bacteria in instant food is more than 3 parts by weight, the amount does not have a great effect on the inhibition of the growth of harmful microorganisms and promotion of users' health while manufacturing costs are increased and instant food becomes less tasty.

In this case, the lactic acid bacteria is resistant to heat and formed in powder, and being resistant to heat means enough survival rates at cooking temperature and during cooking and preferably means about 60% or more survival rates. The lactic acid bacteria may be selected in the nature, may be processed by means of mutation, or microcapsule-type lactic acid bacteria in which lactic acid bacteria, weak to heat, are contained in a capsule so as to artificially add heat resistance may be used. However, Lactobacillus sporogenes that has excellent thermal resistance without the above-described preprocessing is preferably used.

Lactobacillus sporogenes is a bacterial species between Lactobacillus and Bacillus, is a thermophilic bacteria species generating L(+) lactic acid by means of homo fermentation, is a specific bacterial species that obtains energy by means of both of the fermentation and breathing, is metabolized by fermentation with a culture medium rich in fermentable sugar, has the ability to generate lactic acid more than 90% by means of fermentation of sugar, is metabolized by breathing in an aerobic environment with a breakdown product of proteins having less sugar such as yeast extract and peptone, and has excellent tolerance, and is a spore-forming lactic acid bacterium generating spores 90 or more %.

Further, the roe preferably consists of one or more selected from a group consisting of salmon roe, walleye pollock roe, flying fish roe, and herring roe. If roe consisting of the above-described roe is contained in instant food, the instant food is rich in nutrients and has a good texture of food. If the content of the above-described roe in instant food is less than 3 parts by weight, the instant food are not rich in nutrients and a texture of food of the instant food is not that great. If the content of the above-described roe in instant food is more than 5 parts by weight, manufacturing costs are increased, the instant food becomes less tasty, and consumers' preferences are negatively influenced.

The solid ingredient stacking step S103 is a step of putting, into an instant food cooking container, a soup formation manufactured through the soup forming step S101 and stacking and adding solid ingredients for instant food. A soup formation is first put into an instant food cooking container so as to be positioned on the inner bottom surface of the instant food cooking container, and then solid ingredients are stacked at the upper side of the soup formation. In this case, the solid ingredients are preferably 15 to 25 mm thick.

Through the solid ingredient stacking step S103, a soup formation is first stacked on the inner bottom surface of an instant food cooking container, and on top of this, solid ingredients, primarily cooked, frozen and formed, are stacked. When hot water is supplied, the solid ingredients are melted to some degree, and the hot water and the soup formation are heated together by an induction device. Accordingly, spices of the heated and melted soup formation evenly permeate into the solid ingredients.

In this case, if the solid ingredients are less than 15 mm in thickness, there is too much of a solid ingredient thereby making the instant food less tasty and negatively affecting the texture of the instant food. If the solid ingredients are more than 25 mm in thickness, heat sources generated by an induction device escape from the range in which the heat sources are delivered. Accordingly, much time is spent on cooking the instant food.

In this case, the solid ingredients consist of a variety of spices and ingredients such as cooked rice, pepper, onions, garlic and a white radish, and the detailed ingredients of the solid ingredients vary according to sorts of instant food.

The packaging step S105 is a step of sealing the open mouth of the instant food cooking container in which solid ingredients are accommodated in the state of being stacked on a soup formation through the solid ingredient stacking step S103. The open mouth of the instant food cooking container in which a soup formation and solid ingredients are consecutively stacked through the solid ingredient stacking step S103 is covered by a cover, and the open mouth and the cover are sealed by means of a usual method so as to prevent instant food from going bad and to improve instant food preservation.

After the packaging step S105, the instant food may be cooked through a device for heating and cooking instant food that will be described hereafter.

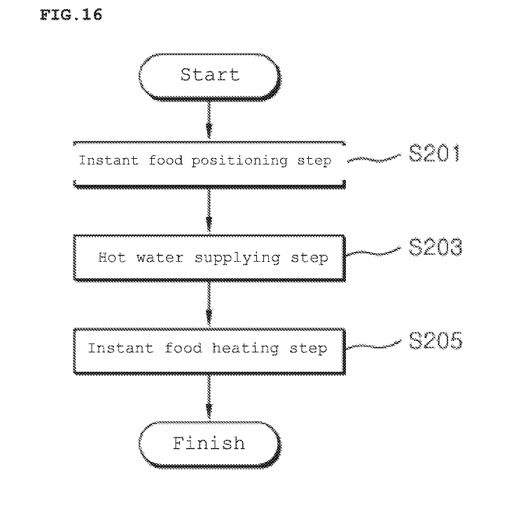

That is, the instant food manufactured through the above-described steps, as illustrated in FIG. 16, may be cooked through an instant food positioning step S201 of mounting, onto a device for heating and cooking instant food, packaged instant food manufactured through the method of manufacturing instant food capable of being inductively cooked, a hot water supplying step S203 of supplying hot water into an instant food cooking container mounted onto the device for heating and cooking instant food through the instant food positioning step S201, and an instant food heating step S205 of heating hot water, supplied into the instant food cooking container through the hot water supplying step S203, a soup formation and solid ingredients through the device for heating and cooking instant food.

The instant food positioning step S201 is a step of mounting, onto a device for heating and cooking instant food, an instant food cooking container in which a soup formation and solid ingredients, manufactured through the method for manufacturing instant food capable of being inductively cooked, are accommodated in the state where a cover of the instant food cooking container is not opened.

The hot water supplying step S203 is a step of making a hot water nozzle of a device for heating instant food penetrate the cover of the instant food cooking container mounted onto the device for heating and cooking instant food through the instant food positioning step S201, and then supplying, inside the instant food cooking container, hot water supplied through the hot water nozzle. In this case, 280 to 320 parts by weight of hot water is preferably supplied with respect to 100 parts by weight of solid ingredients so as to put a soup formation and solid ingredients under the hot water.

If the amount of supplied hot water is less than 280 parts by weight, the supplied water is much less than a soup formation in the instant food cooking container thereby leading to an increase in the salinity of the soup of cooked instant food. If the amount of supplied hot water is less than 320 parts by weight, the salinity of cooked instant food is too low thereby negatively influencing consumers' preferences.

In this case, the temperatures of the hot water preferably range from 50 to 100° C. If the temperature of the hot water is less than 50° C., it takes a long time to cook instant food with a heat source generated by the device for heating and cooking instant food, and the temperature adversely affects the texture of instant food.

The instant food heating step S205 is a step of heating the hot water, supplied inside the instant food cooking container through the hot water supplying step S203, the soup formation, and the solid ingredients by a device for heating and cooking instant food. That is, the hot water, the soup formation, and the solid ingredients in the instant food cooking container are heated at temperatures ranging from 200 to 400° C. for 60 to 90 seconds by the device for heating and cooking instant food through the instant food heating step S205.

In general, in the case of the contents heated at the above-described temperatures for the above-described period of time, various seasonings maintain their flavors and rice has an excellent texture. Additionally, only a small amount of hot water is evaporated because instant food is rapidly heated, thereby preventing an increase in the salinity of the contents.

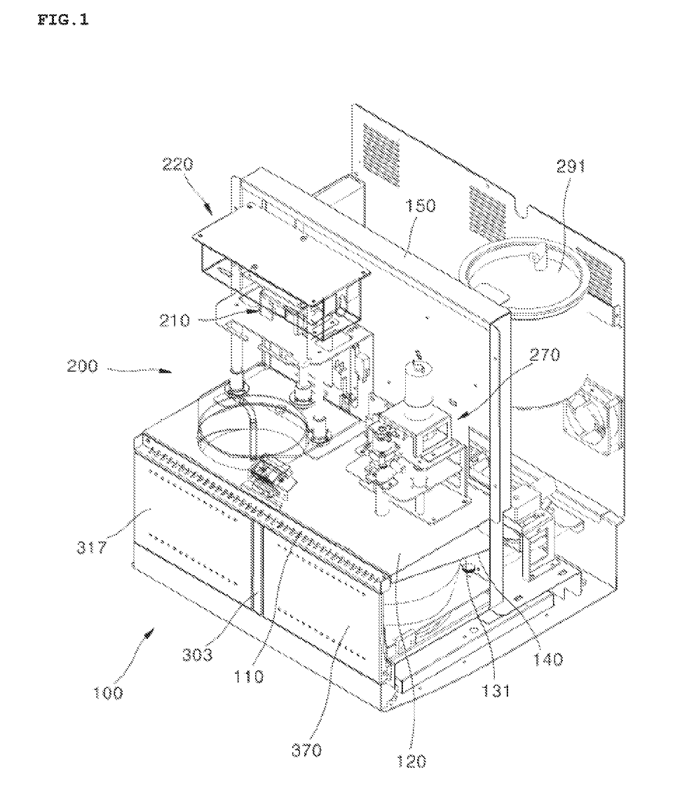

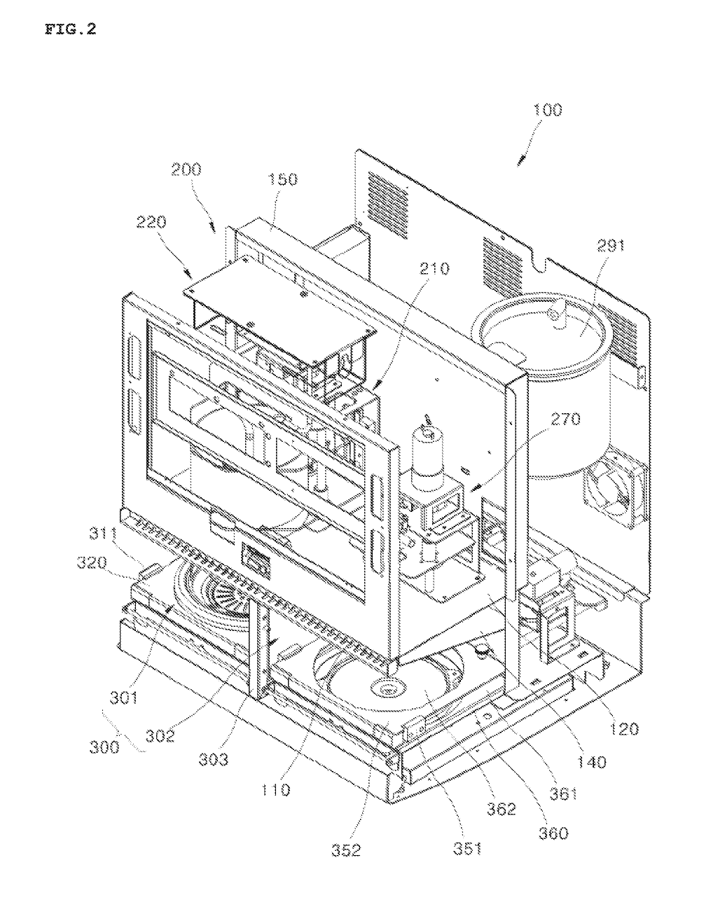

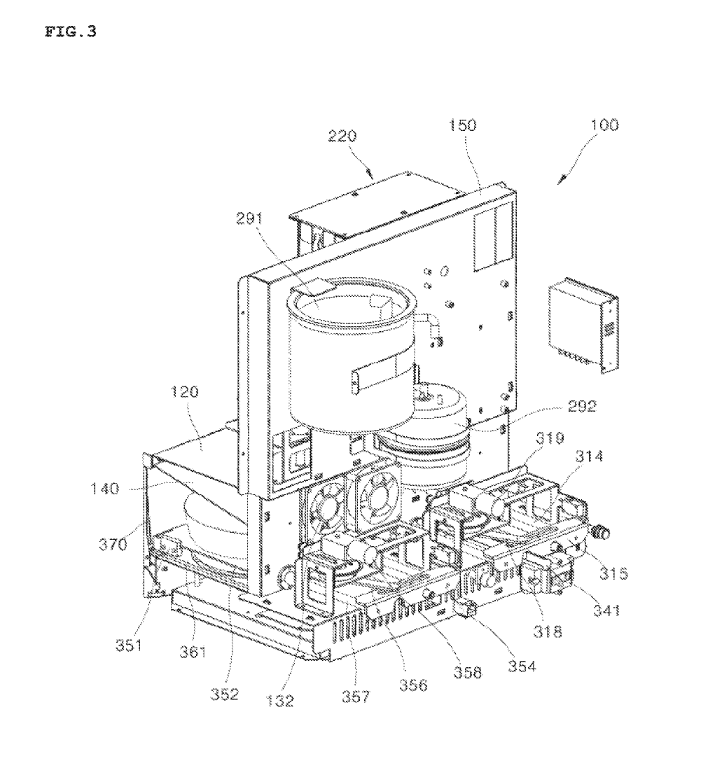

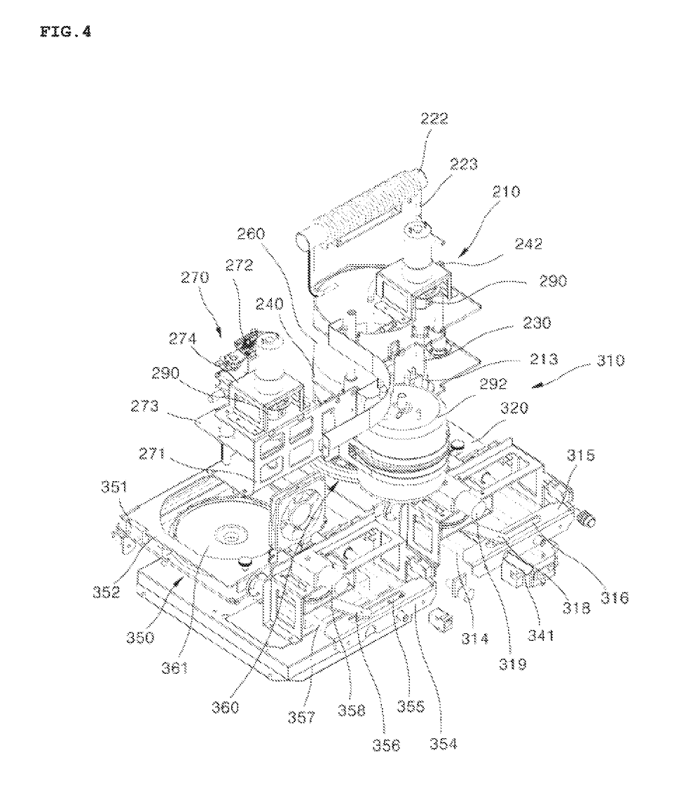

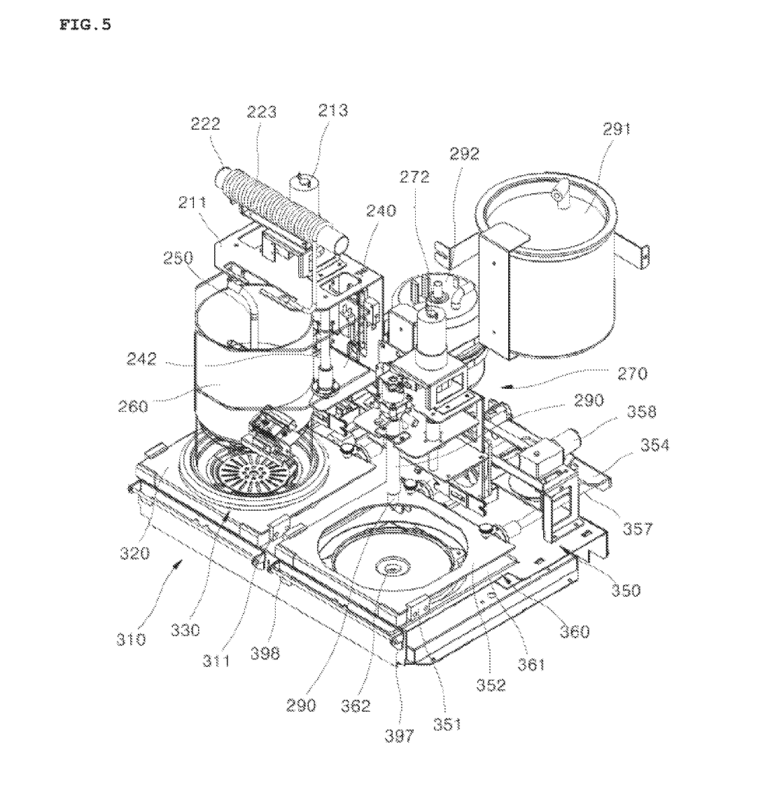

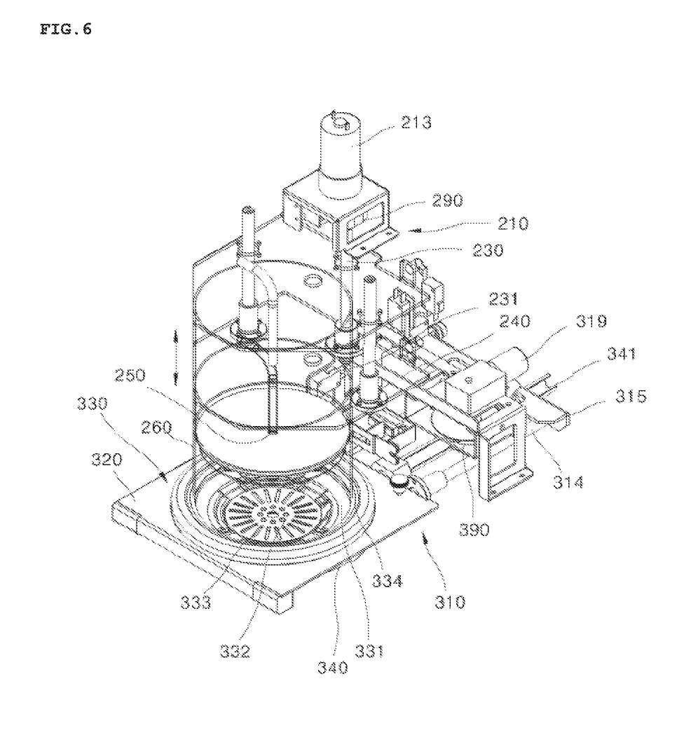

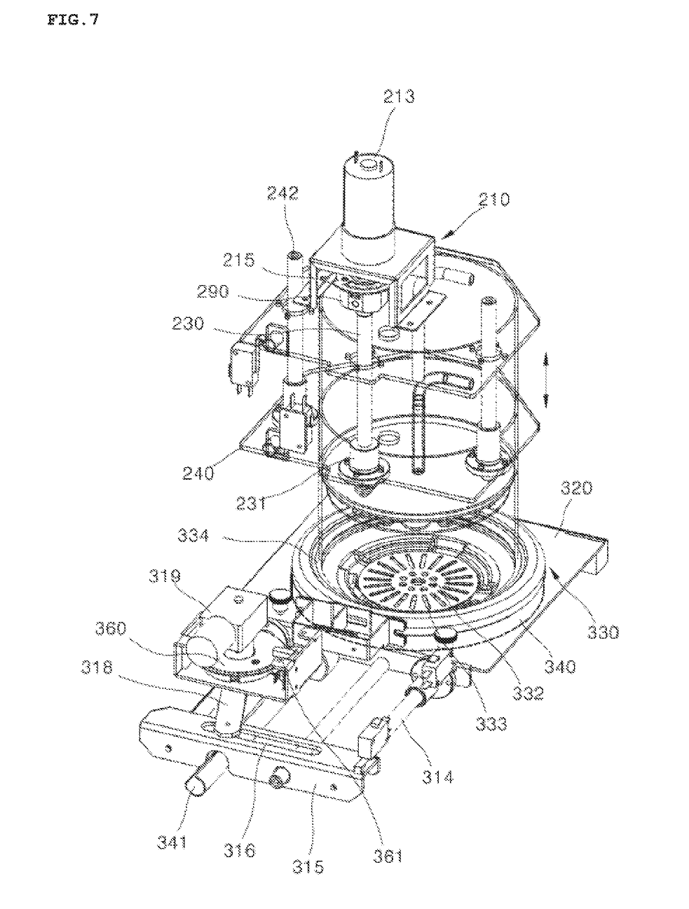

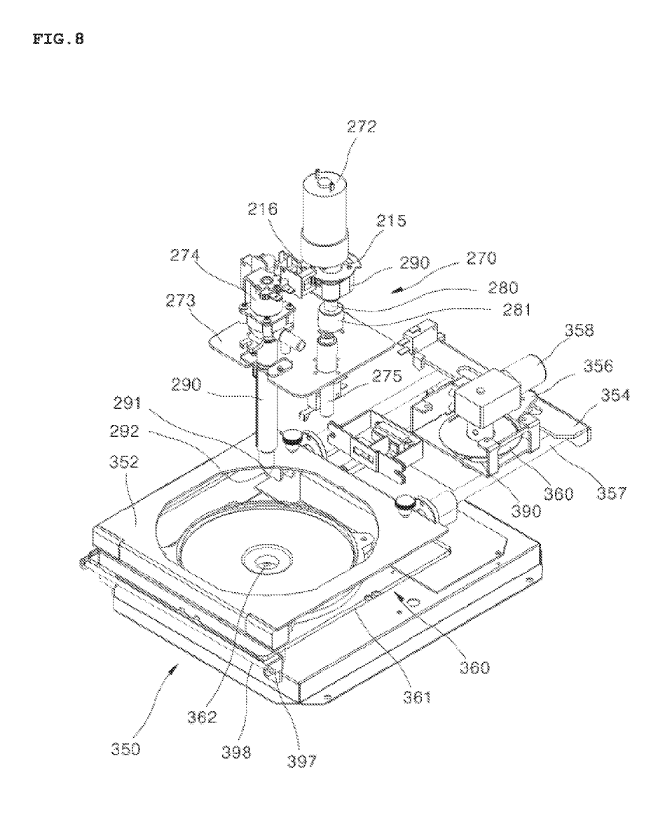

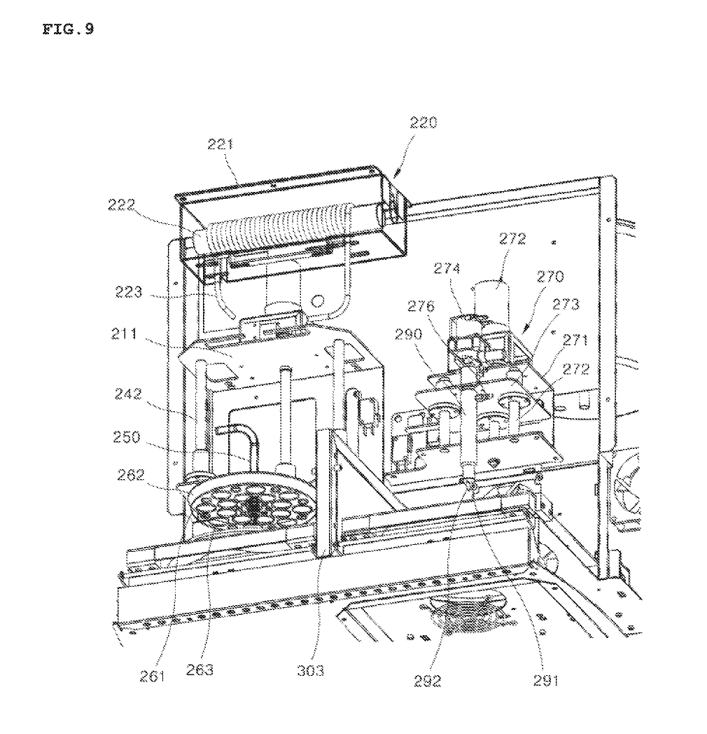

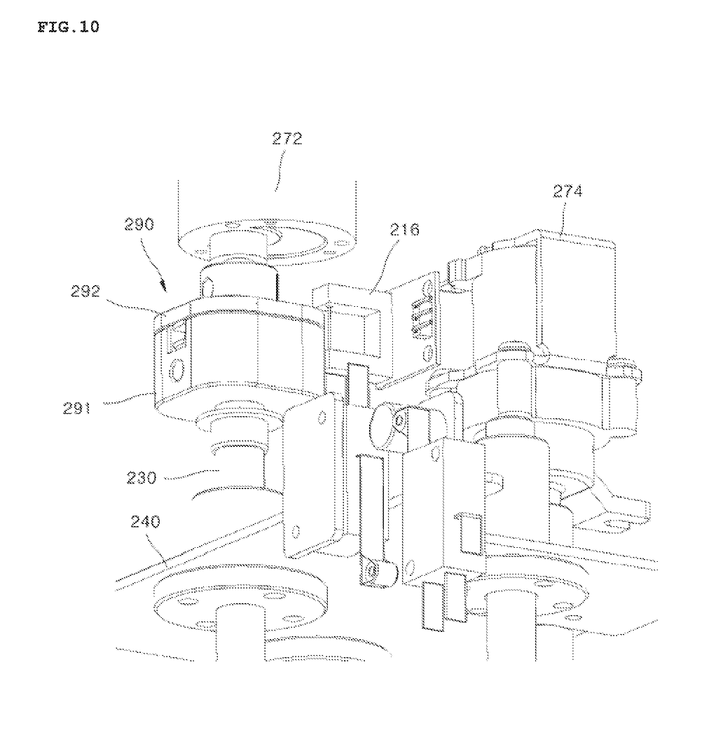

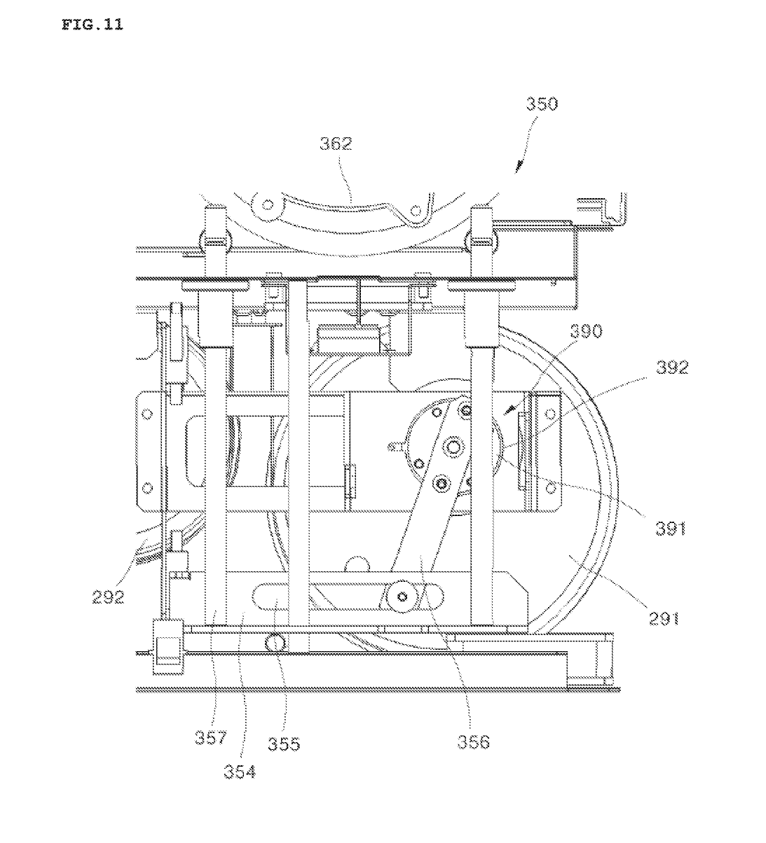

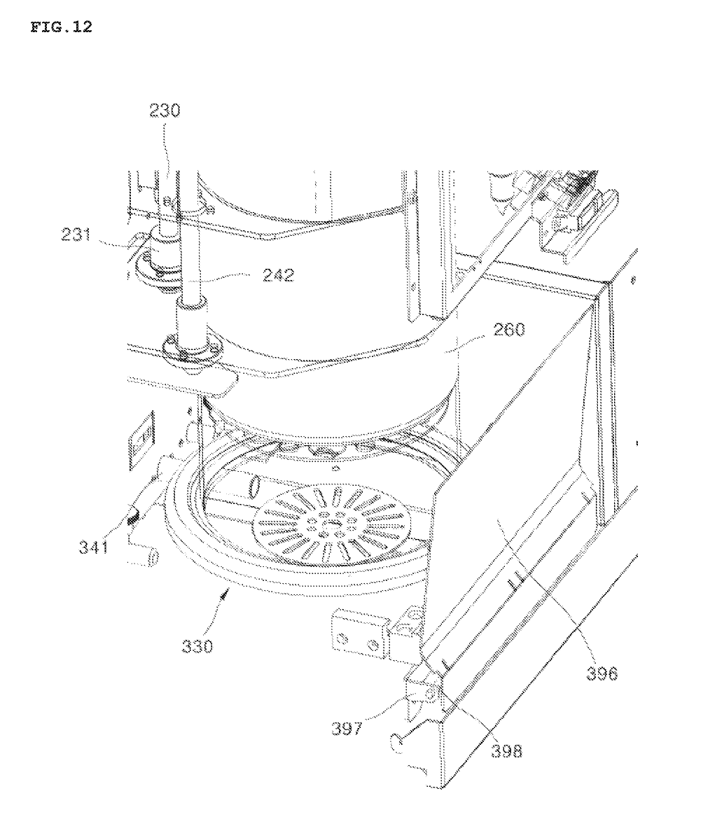

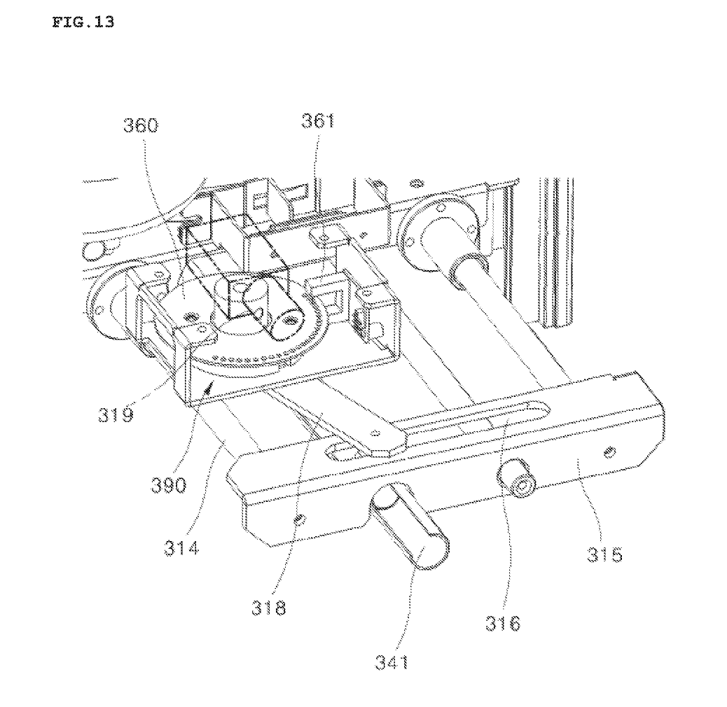

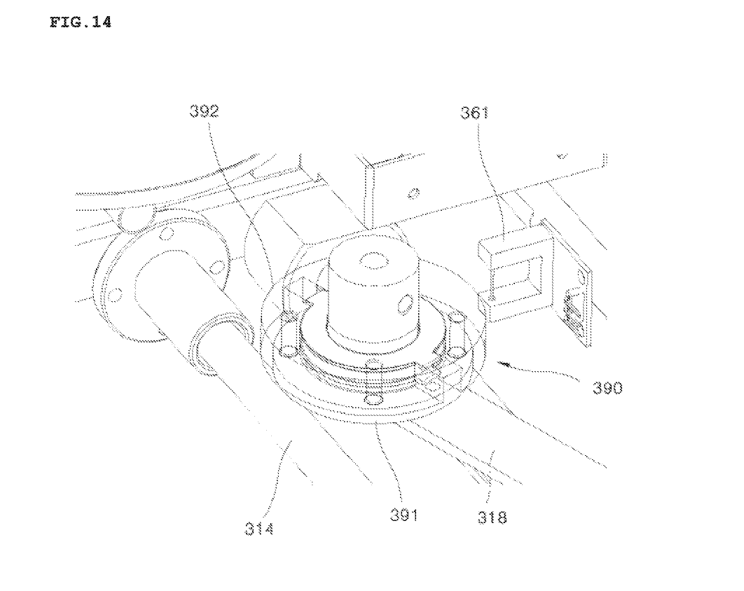

Meanwhile, various devices for heating and cooking instant food can be used as the device for heating and cooking instant food. According to a preferred embodiment of the present invention, a device for heating and cooking instant food using stem and induction may be configured as the device for heating and cooking instant food. The components of the device for heating and cooking instant food, as illustrated in FIGS. 1 to 14, are largely divided into a body 100 provided with a space above and below an exhaust duct part 110 and a horizontal partition plate 120, an electric outfitting part 200 including a steam generating part 210, a hot water generating part 270, and a cool water storage tank 410 that are provided at the upper space of the body 100, and a cooking part 300 including an open and closed type steam heating part 310 and an open and closed type induction heating part 350 that are respectively positioned in a first cooking space 301 and second cooking space 302 in the lower space of the body 100. Each of the components will be described in detail with reference to the attached drawing.

First, the body 100 forms an external shape of a device for heating and cooking instant food, has a box shape which is approximately rectangular-shaped, has a “┘”-shaped grill type exhaust duct part 110 for ventilating inner heat at the center of the front surface thereof in the widthwise direction thereof, and has a horizontal partition plate 120 horizontally installed in the rear of the exhaust duct part 110 such that the electric outfitting part 200 is configured above the horizontal partition plate 120 and that the cooking part 300 is configured below the horizontal partition plate 120.

The horizontal partition plate 120 connects with a vertical bracket 150 whose end is vertically erected and installed inside the body 100, and the inside of the body 100 is divided into the front and rear by the vertical bracket 150.

With respect to the vertical bracket 150, a steam generating part 210, a hot water generating part 270, an open and closed type steam heating part 310 and an open and closed type induction heating part 350 that will be described hereafter are positioned at the front of the inside of the body 100, and with respect to the vertical bracket 150, a cool water storage tank 410, a hot water tank 420, a power supplying device, an earth leakage circuit breaker (ELCB), a cooling fan, a communication terminal, various switches and sensors, a control part for controlling the power supplying device, and a driving means for driving the open and closed type steam heating part 310 and the open and closed type induction heating part 350 are positioned at the rear of the inside of the body 100.

The body 100 is provided with a steam generating part 210 for generating high-temperature steam, and a hot water generating part for generating hot water 270 in the electric outfitting part 200 at the upper side divided by the horizontal partition plate 120, and is provided with an open and closed type steam heating part 310 for cooking instant food for steam cooking, and an open and closed type induction heating part 350 for cooking instant food using hot water and an induction device in the cooking part 300 at the lower side divided by the horizontal partition plate 120.

A display unit for displaying advertisements and information regarding cooking, and a camera, a sensor, or a code recognition device etc. for recognizing a product or for determining existence and nonexistence of a user are installed on the upper side of the front surface of the body 100, and an opening and closing door 317, 370 for separately opening and closing the inner space of the cooking part 300 is installed on the lower side of the front surface of the body 100.

The cooking part 300 is divided by a wall 303, installed vertically at the center of the lower side of the front surface of the body 100, into a first cooking space 301 and a second cooking space 302. The first cooking space 301 is installed on one side with reference to the wall and the second cooking space 302 is installed on the other side with reference to the wall.

That is, the first cooking space 301 is one space formed by the inner surface of the lateral plate of one side of the body 100, the lateral surface of one side of the wall 303, the lower surface of one side of the horizontal partition plate 120, and the front surface of the vertical bracket 150, and is configured to be opened and closed by the opening and closing door 317 that will be described hereafter.

The second cooking space 302 is another space formed by the inner surface of the lateral plate of the other side of the body 100, the lateral surface of the other side of the wall 303, the lower surface of the other side of the horizontal partition plate 120, and the front surface of the vertical bracket 150, and is configured to be opened and closed by the opening and closing door 370 that will be described hereafter.

A guide board 140 may be further installed at the lower portion of the horizontal partition plate 120 of the body 100. One end of the front of the guide board 140 connects with the rear surface of the exhaust duct part 110, and the other end the rear of the guide board 140 connects with the front surface of the vertical bracket 150 of the first cooking space 301 and the second cooking space 302. Preferably, the other end of the rear of the guide board 140 may be configured to incline and to be lower than one end of the front of the guide board 140, and more preferably, a plurality of exhaust passages 131 are formed at the front surface of the vertical bracket 150 of the second cooking space 302, and a plurality of exhaust fans 132 configured to connect with the exhaust passages 131 are formed at the rear surface of the vertical bracket 150 of the second cooking space 302 such that moisture and smells generated in the second cooking space 302 are removed from the second cooking space 302.

A stem generating part 210 is positioned in a space at the upper portion of one side of the body 100, generates steam and supplies the seam inside a container for cooking instant food for steam cooking placed in the first cooking space 301 on the lower side of the steam generating part.

The steam generating part 210 may include a support frame 211, a steam generator 220, a forward and reverse speed reduction motor 213, a screw member 230, an ascending and descending plate 240, a steam nozzle 250, and a steam cover 260.

First, the support frame 211 is configured to have an approximate “⊃” shape, is configured to have a certain height, is installed at the upper surface of the horizontal partition plate 120, is provided with an ascending and descending plate 240, a steam nozzle 250, a steam cover 260, and a screw member 230 and a nut member 231, moving the ascending and descending plate 240, the steam nozzle 250, and the steam cover 260 upwards and downwards, therein, and has the steam generator 220 which is hanging from the inner surface of the upper plate of the body 100 and is installed at the upper portion of the support frame 211.

One side of the steam generator 220 connects with a hot water tank 420 for maintaining the temperature of cool water, received from a cool water storage tank 410, at a set temperature through a heating means, and the other side of the steam generator 220 connects with a steam nozzle 250 such that hot water supplied by the hot water tank 420 is turned into hot-temperature steam in the process of passing the steam generator 220 and then is sprayed outwards through the steam nozzle 250.

Detailed embodiments of the steam generator 220 will be described as follows.

The steam generator 220 may include an insulation case 221, a heater member 222, a heat exchange pipe 223. The insulation case 221 is divided into an upper portion and a lower portion. The upper portion is coupled to the lower surface of the upper plate of the body 100, and the lower portion coupled to the upper portion has an approximately rectangular-shaped inner space at which a heater member 222 having a circular pipe shape like a rod is installed in the lengthwise direction of the insulation case.

A heat exchange pipe 223 is wound several times around the outer circumferential surface the heater member 222. One side of the heat exchange pipe 223 connects with the hot water tank 420 for maintaining the temperature of cool water received from the cool water storage tank 410 at a set temperature, and the other side of the heat exchange pipe 223 connects with the upper end of the steam nozzle 250.

The heater member 222 and the heat exchange pipe 223 may be integrally configured through casting, and may be separately manufactured so as to be assembled.

The heater member 222 may be installed through a space maintaining device so as to be spaced apart from the bottom surface of the lower portion of the insulation case 221 to a certain height. A plurality of through holes are formed at the bottom surface of the lower portion of the insulation case so as to allow the heat exchange pipe 223 to penetrate, and a temperature sensor for sensing the temperature of the heater member 222 is installed inside the insulation case 221.

The heater member 222 generates heat by means of power supplied from the outside, is linked with the temperature sensor installed inside the insulation case 221 and controls temperature such that the temperature corresponds to a set temperature of the steam generator 220.

Meanwhile, the forward and reverse speed reduction motor 213 is installed on the upper surface of the support frame 211. The shaft of the forward and reverse speed reduction motor 213 faces vertically downwards, and a screw member 230 having a certain length and a clutch member 290 are installed at the shaft. A nut member 231 rotatably joins the lower portion of the screw member 230, and a horizontal ascending and descending plate 240 is installed at the nut member 231 such that the ascending and descending plate 240 together with the nut member 231 moves up and down according to the direction of the rotation of the screw member 230.

Guide members 242 are respectively installed vertically upwards and downwards on both sides inside the support frame 211, and both sides facing the ascending and descending plate 240 are slidably coupled to the guide members 242.

As a result, when the forward and reverse speed reduction motor 213 is driven, the screw member 230 together with the clutch member 290 rotates in the front direction or in the reverse direction, and the nut member 231 and the ascending and descending plate 240 move up or down according to the rotation of the screw member 230. Herein, if the screw member 230 stops rotating unnecessarily, the forward and reverse speed reduction motor 213 is overloaded. However, the forward and reverse speed reduction motor 213 can be prevented from being damaged according to the slip of the clutch member 290 provided to the screw member 230.

An embodiment of the clutch member 290 includes a housing 291 in which the upper end of the screw member 230 penetrates and is installed, and a cover 292 coupled to the opened upper surface of the housing 291, at the center of the lower surface of the housing. The end of the shaft of the forward and reverse speed reduction motor 213, penetrating the upper surface of the cover 292, and the upper end of the screw member 230, penetrating the lower surface of the housing 291, are connected through a connecting member, a washer, and a plurality of plate sprigs. As a result, the rotational force of the forward and reverse speed reduction motor 213 is usually delivered to the screw member 230. However, if the screw member 230 stops unnecessarily, the connecting member slips so as to prevent the rotational force of the forward and reverse speed reduction motor 213 from being delivered to the screw member 230.

As an example, a plurality of limit switches are installed on the moving path of the ascending and descending plate 240 so as to control the height at which the ascending and descending plate 240 moves up and down. As a result, when the limit switches operate according to the ascending and descending of the ascending and descending plate 240, a control part connecting with the limit switches senses signals of the limit switches and controls the driving of the forward and reverse speed reduction motor 213 so as to control the height at which the ascending and descending plate 240 moves up and down.

As another example, a sensing means is placed at the shaft of the forward and reverse speed reduction motor 213 and senses the frequency of the rotation of the forward and reverse speed reduction motor so as to control the height at which the ascending and descending plate 240 moves up and down. The control part determines value sensed by the sensing means and controls the driving of the forward and reverse speed reduction motor 213 so as to control the height at which the ascending and descending plate 240 moves up and down.

Herein, as a method for sensing the frequency of the shaft of the forward and reverse speed reduction motor 213, a disk 215, capable of rotating together with the shaft of the forward and reverse speed reduction motor 213, is installed at the upper side of the clutch member 290. If a photo sensor 216 is installed near one side of the disk 215, the photo sensor 216 may sense the disk 215 rotating together with the shaft of the forward and reverse speed reduction motor 213, and the control part connecting with the photo sensor 216 may sense the frequency of the shaft of the forward and reverse speed reduction motor 213.

Meanwhile, a steam nozzle 250 that has a certain length vertically downwards is installed at the center of the ascending and descending plate 240. The upper end of the steam nozzle 250 penetrates the ascending and descending plate 240 and connects with the other side of the above-described heat exchange pipe 223 of the steam generator 220. Additionally, a sharp part 251 provided with one or more spraying holes 252 is formed at the lower end of the steam nozzle 250.

The spraying holes 252 of the steam nozzle 250 spray steam moving through the steam nozzle 250 out of the stem nozzle 250, and the sharp part 251 assists the lower end of the steam nozzle 250 such that the lower end of the steam nozzle 250 easily penetrates the upper surface of the cover of the container for cooking instant food for steam cooking.

The steam nozzle 250 at the lower portion of the ascending and descending plate 240 penetrates the center of the upper surface of the ascending and descending plate downwards, and an open cylindrical steam cover 260 is provided to the lower surface of the ascending and descending plate 240 such that the steam cover 260 and the steam nozzle 250 move downwards and move to the first cooking space 301 of the cooking part 300 through the horizontal partition plate 120, when the ascending and descending plate 240 moves downwards.

In this case, if the container for cooking instant food for steam cooking is paced in the first cooking space 301, the container for cooking instant food for steam cooking is covered by the steam cover 260 moving down, and the sharp part 251 of the steam nozzle 250 penetrates the upper surface of the cover of the container for cooking instant food for steam cooking and is placed inside the container for cooking instant food for steam cooking. When high-temperature steam is sprayed from the spraying holes 252 of the sharp part 251 through the steam nozzle 250, cooking water inside the container for cooking instant food for steam cooking may be cooked by the high-temperature steam.

Herein, when the sharp part 251 of the steam nozzle 250 penetrates the upper surface of the cover of the container for cooking instant food for steam cooking and then steam is sprayed into the container for cooking instant food for steam cooking out of the spraying holes 252 of the sharp part 251, the sprayed steam can make the cover of the container for cooking instant food for steam cooking inflate or float. In some cases, the steam can counter-flow and escape through a part of the cover, torn by the sharp part 251.

Thus, a circular plate-shaped container pressurizing plate 261, whose center is penetrated by the steam nozzle 250 and which is in parallel with the upper surface of the steam cover 260 such that the outer circumference of the circular plate-shaped container pressurizing plate gets close to or movably contacts the inner circumferential surface of the steam cover 260, is installed inside the steam cover 260. When the sharp part 251 of the steam nozzle 250 penetrates the upper surface of the cover of the container for cooking instant food for steam cooking, the container pressurizing plate 261, kept at a constant distance from the sharp part 251, presses the upper surface of the cover of the container for cooking instant food for steam cooking. As a result, steam supplied into the container for cooking instant food for steam cooking does not make the cover of the container for cooking instant food for steam cooking inflate or unnecessarily float. Further, the steam is prevented from counter-flowing and escaping through a part of the upper surface of the cover, torn by the sharp part 251.

One or more vent holes 263 are formed at the surface of the container pressurizing plate 261, and this is to allow the container pressurizing plate 261 to effectively separate from the upper surface of the cover of the container for cooking instant food for steam cooking when the container pressurizing plate 261 contacts the upper surface of the cover of the container for cooking instant food for steam cooking and then separates from the upper surface of the container for cooking instant food for steam cooking according to the ascending of the steam cover 260.

The sharp part 251 of the steam nozzle 250 may be integrally formed at the end of the steam nozzle 250 or may be configured to be detachable so as to be detached from and assembled to the end of the steam nozzle 250.

If the sharp part 251 is configured to be detached from the steam nozzle 250, the sharp part 251 disposed to contamination may be easily cleaned and managed.

Also, the sharp part 251 and the container pressurizing plate 261 may be formed separately. However, the sharp part 251 and the container pressurizing plate 261 may be integrally formed and be installed so as to be detached from the steam nozzle 250.

A circular plate-shaped steam blocking plate 262, whose center is penetrated by the steam nozzle 250 toward the upper side of the container pressurizing plate 261 and which is in parallel with the upper surface of the steam cover 260 such that the outer circumferential surface of the steam blocking plate comes into close contact with the inner circumferential surface of the steam cover 260, may be further provided inside the steam cover 260. The steam blocking plate 262 may prevent some of the stem, sprayed into the container for cooking instant food for steam cooking, from moving to the electric outfitting part 200 through the upper surface of the steam cover 260.

A hot water generating part 270 is placed in the above-described space of the upper portion of the other side of the body 100 and is configured to supply hot water into the instant food cooking container placed in a second cooking space 302 at the lower side of the body 100. The hot water generating part 270 may include a guide frame 271, a forward and reverse speed reduction motor 272, a screw member 278, an ascending and descending plate 273, a hot water nozzle 280, and a solenoid valve 274.

First, the guide frame 271 is configured to have an approximate “⊃” shape, is configured to have a certain height, is installed at the upper surface of the horizontal partition plate 120, is provided with a forward and reverse speed reduction motor 272 at the upper portion thereof, and is provided with a hot water nozzle 280 therein. The hot water nozzle 280 includes an ascending and descending plate 273, a screw member 278 for moving the ascending and descending plate 273 upwards and downwards, a nut member 279, and a solenoid valve 274.

The shaft of the forward and reverse speed reduction motor 272, installed on the upper portion of the guide frame 271 so as to move the ascending and descending plate 273 upwards and downwards, faces vertically downwards, and a screw member 278 and a clutch member 290 are installed at the shaft. A nut member 279 rotatably joins the lower portion of the screw member 278, and a horizontal ascending and descending plate 273 is installed at the nut member 279 such that the ascending and descending plate 273 together with the nut member 279 moves up and down according to the direction of the rotation of the screw member 278.

Guide members 275 are respectively installed vertically upwards and downwards on both sides inside the guide frame 271, and both sides facing the ascending and descending plate 273 are slidably coupled to the guide members 275.

As a result, when the forward and reverse speed reduction motor 272 is driven, the screw member 278 together with the clutch member 290 rotates in the front direction or in the reverse direction, and the nut member 279 and the ascending and descending plate 273 move up or down according to the rotation of the screw member 278. Herein, if the screw member 278 stops rotating unnecessarily, the forward and reverse speed reduction motor 272 is overloaded. However, the forward and reverse speed reduction motor 272 can be prevented from being damaged according to the slip of the clutch member 290 provided to the screw member 278.

An embodiment of the clutch member 290 includes a housing 291 at which the upper end of the screw member 278 is installed so as to penetrate the center of the lower surface of the housing 291, and a cover 292 coupled to the opened upper surface of the housing 291. The end of the shaft of the forward and reverse speed reduction motor 272, penetrating the upper surface of the cover 292, and the upper end of the screw member 278, penetrating the lower surface of the housing 291 are connected through a connecting member, a washer, and a plurality of plate sprigs. As a result, the rotational force of the forward and reverse speed reduction motor 272 is usually delivered to the screw member 278. However, if the screw member 278 stops unnecessarily, the connecting member slips so as to prevent the rotational force of the forward and reverse speed reduction motor 272 from being delivered to the screw member 278.

As an example, a plurality of limit switches are installed on the moving path of the ascending and descending plate 273 so as to control the height at which the ascending and descending plate 273 moves up and down. As a result, when the limit switches operate according to the ascending and descending of the ascending and descending plate 273, a control part connecting with the limit switches senses signals of the limit switches and controls the driving of the forward and reverse speed reduction motor 272 so as to control the height at which the ascending and descending plate 273 moves up and down.

As another example, a sensing means is placed at the shaft of the forward and reverse speed reduction motor 272 and senses the frequency of the rotation of the forward and reverse speed reduction motor so as to control the height at which the ascending and descending plate 273 moves up and down. The control part determines value sensed by the sensing means and controls the driving of the forward and reverse speed reduction motor 272 so as to control the height at which the ascending and descending plate 273 moves up and down.

Herein, as a method for sensing the frequency of the shaft of the forward and reverse speed reduction motor 272, a disk 215, capable of rotating together with the shaft of the forward and reverse speed reduction motor 272, is installed at the upper side of the clutch member 290. If a photo sensor 216 is installed near one side of the disk 215, the photo sensor 216 may sense the disk 215 rotating together with the shaft of the forward and reverse speed reduction motor 272, and the control part connecting with the photo sensor 216 may sense the frequency of the shaft of the forward and reverse speed reduction motor 272.

The solenoid valve 274 is installed at the upper portion of the ascending and descending plate 273. A hot water tank 420 connects with one side of the solenoid valve 274, and the upper end of the hot water nozzle 280 connects with the other side of the solenoid valve 274.

The solenoid valve 274 is controlled by the control part so as to supply or to stop supplying hot water to the hot water nozzle 280.

The hot water nozzle 280 is configured to have a certain length and extend vertically downwards in the state where the hot water nozzle is fixed to the front of the ascending and descending plate 273, and has a sharp part 281, provided with discharging holes 282, at the end of the lower side thereof.

The sharp part 281 of the hot water nozzle 280 may be integrally formed at the end of the hot water nozzle 280 or may be configured to be detachable so as to be detached from and assembled to the end of the hot water nozzle 280.

If the sharp part 281 is configured to be detached from the hot water nozzle 280, the sharp part 281 disposed to contamination may be easily cleaned and managed.

An air injecting nipple 276 may be installed at one side of the hot water nozzle 280.

If the supply of hot water by the hot water nozzle 280 stops, some of the hot water is maintained in the pipe channel of the hot water nozzle 280 by means of the inner pressure of the hot water nozzle 280. In this case, when the air injecting nipple 276 is opened, air is introduced into the hot water nozzle 280, and pressure changes. Accordingly, the water maintained in the pipe channel is discharged outwards. As a result, the hot water nozzle 280 is hygienically managed.

That is, when the forward and reverse speed reduction motor 272 operates and then the screw member 278 rotates, the ascending and descending plate 273 and the hot water nozzle 280 move down, such that the sharp part 281 of the hot water nozzle 280 penetrates the upper surface of the cover of the instant food cooking container placed in the second cooking space 302 and that hot water supplied by the hot water tank 420 passes the hot water nozzle 280 and is supplied into the instant food cooking container through the discharging holes 282 of the sharp part 281 placed inside the instant food cooking container according to the control of the solenoid valve 274.

When a fixed amount of hot water is supplied into the instant food cooking container, the solenoid valve 274 stops supplying hot water flowing into the hot water nozzle 280, and the air injecting nipple 276 operates to inject air into the hot water nozzle 280 and discharges hot water maintained in the hot water nozzle 280 into the instant food cooking container. Then, the ascending and descending plate 273 and the hot water nozzle 280 move up to a place where the ascending and descending plate 273 and the hot water nozzle 280 were according to the reverse rotation of the screw member 278 when the forward and reverse speed reduction motor 272 operates reversely.

Then, the instant food cooking container, placed in the second cooking space 302 and receiving hot water from the hot water nozzle 280, is heated, and the instant food is cooked by means of an open and closed type induction heating part 350.

Herein, induction heating bodies in the form of a thin plate or powder are provided outside the instant food cooking container, or are provided inside the instant food cooking container and then coated for safety, or are stacked between the inner surface and the outer surface of the instant food cooking container such that the open and closed type induction heating part 350 heats the contents such as the hot water, a soup formation and solid ingredients inside the instant food cooking container by means of induction heating.

An open and closed type stem heating part 310 is provided in the above-described first cooking space 301 of the cooking part 300 and may include guide rails 311, a shuttling plate 320, a steam cooking stand 330, transfer guides 314, a transfer connecting member 315, a driving motor 319, a crank member 318, and an opening and closing door 317.

The guide rails 311 are installed to face both facing lateral sides inside the above-described first cooking space 301, and both lateral sides of the shuttling plate 320 with a horizontal plane shape are slidably fitted into and coupled to the guide rails 311 such that the shuttling plate 320 comes in and out of the first cooking space 301.

The shuttling plate 320 has a hole at the center of the upper surface thereof, and the lower portion of the steam cooking stand 330 is fitted into the hole.

A round shape mounting groove 331 onto which a container for cooking instant food for steam cooking can be mounted is formed inside the steam cooking stand 330, a drain plate 332 is detachably installed at the center of the mounting groove 331, a plurality of drain holes 333 are formed at the drain plate 332 such that water moving to the drain plate 332 is discharged out of the drain holes 333, and the water discharged out of the drain holes is discharged outwards through a through hole formed at the center of the steam cooking stand 330.

Preferably, a drain container 340 is installed at the lower portion of the steam cooking stand 330 such that water discharged through the through hole gathers in the drain container 340. One side of a drain pipe penetrates and is installed at the rear surface of the drain container 340, and the end of the other side of the drain pipe 341 is withdrawn outside the body 100.

The drain pipe 341 is preferably configured to be controlled in length according to the forward and backward movements of the shuttling plate 320. For instance, the drain pipe 341 is configured to be foldable in multiple stages like an antenna.

Water gathered in the drain container 340 may be discharged outside the body 100 through the drain pipe 341, and the drain pipe 341 may be configured to be inclined from the drain container 340 toward the outside of the body 100.

A container for cooking instant food for steam cooking is fitted into the mounting groove 331 of the steam cooking stand 330 so as not to easily separate from the steam cooking stand 330 when the container for cooking instant food for steam cooking is mounted onto the mounting groove 331. This is to prevent the container for cooking instant food for steam cooking from unnecessarily floating in the process of supplying high-temperature steam into the container for cooking instant food for steam cooking through the steam nozzle 250 at constant pressure.

A round shape sealing member 334 is installed at the outer circumference of the mounting groove 331 of the steam cooking stand 330. Thus, the lower end of the steam cover 260 comes into close contact with the sealing member 334 so as to prevent steam from escaping through the lower surface of the steam cover toward the first cooking space 301 when the steam cover moves down toward the container for cooking instant food for steam cooking, and then the sharp part 251 of the steam nozzle 250 penetrates the upper surface of the cover of the container for cooking instant food for steam cooking and supplies steam into the container for cooking instant food for steam cooking.

Meanwhile, a transfer connecting member 315 is installed at a certain distance from the shuttling plate 320 at the rear of the shuttling plate 320, a long hole-shaped guide hole 316 penetrates and is formed at the upper surface of the transfer connecting member 315, and the transfer connecting member 315 and the shuttling plate 320 are connected by transfer guides 314 at which the transfer connecting member 315 and the shuttling plate 320 faces.

The steam cooking stand 330 is installed at the upper surface of the shuttling plate 320, and the shuttling plate 320 shuttles the inside and outside of the first cooing space 301. To this end, a driving motor 319 is installed at the rear of the first cooking space 301 through a bracket, the shaft of the driving motor 319 connects with a clutch member 390 while facing vertically downwards, one side of a crank member 318 connects with the lower surface of the clutch member 390 while crossing the center of the bottom surface of the clutch member, and the other side of the crank member 318 link-connects with the guide hole 316 at the upper surface of the above-described transfer connecting member 315.

Thus, when the driving motor 319 operates, one side of the crank member 318 rotates by means of the rotation of the clutch member 390. Accordingly, the transfer connecting member 315 link-connecting with the other side of the crank member 318 repeats moving forward and backward. According to the forward and backward movement of the transfer connecting member 315, the shuttling plate 320 moves forward and backward while being guided by the guide of the transfer guides 314.

Herein, in controlling a distance at which the shuttling plate 320 moves, as an example, limit switches positioned on the moving path of the shuttling plate 320 senses the movement of the shuttling plate 320, and a control part connecting with the limit switches determines the sensed movement so as to control the operation of the driving motor 319.

As another example, a disk 380 is installed at the upper portion of the clutch member 390 connecting with the driving motor 319 such that the shaft of the driving motor 319 penetrates the center of the clutch member 390, and a photo sensor 381 capable of recognizing the rotation of the disk 380 is installed together with the disk so as to sense the frequency of the rotation of the shaft of the driving motor 360, and then the control part may control the operation of the driving motor 319.

Herein, the driving motor 319 is driven, and then the shuttling plate 320 shuttles. In this case, if the shuttling plate 320 unintentionally stops, the driving motor 319 is overloaded. However, the driving motor 319 is prevented from being damaged through the slip of the clutch member 390.

An embodiment of the clutch member 390 includes a housing 391 to which the upper surface of one side of the crank member 318 is fixed so as to cross the center of the lower surface of the housing 391, and a cover 392 coupled to the upper portion of the housing 391. The end of the shaft of the driving motor 319, penetrating the upper surface of the cover 392, and one side of the crank member 318 are connected through a connecting member, a washer, and a plurality of plate sprigs. As a result, the rotational force of the driving motor 319 is usually delivered to the crank member 318. However, if the crank member 318 stops unnecessarily, the connecting member slips so as to prevent the rotational force of the driving motor 319 from being delivered to the crank member 318.

An opening and closing door 317 is installed at the front of the first cooking space 301 on the front surface of the body 100 such that the first cooking space 301 is opened and closed according to the forward and backward movement of the shuttling plate 320.

Both facing sides of the lower portion of the opening and closing door 317 are hinge-assembled to an assistant bracket 397 connecting with the body 100 together with a torsion spring. When the shuttling plate 320 moves toward the outside, the upper portion of the opening and closing door 317 rotates toward the front around the lower portion of the opening and closing door by means of external force according to the movement of the shuttling plate such that the first cooking space 301 is opened. In this case, when the torsion spring is stretched and has elasticity, and the shuttling plate 320 moves backwards, the external force applied to the opening and closing door 317 is removed, and the upper portion of the opening and closing door 317 rotates backwards around the lower portion of the opening and closing door by means of the resiliency of the torsion spring such that the first cooking space 301 is closed again.

A support bracket 396 supported by the torsion spring is installed inside the opening and closing door 317. A portion where the support bracket 396 contacts a protruding front surface of the shuttling plate 320 is configured to be curved and protrude toward the shuttling plate 320. When the shuttling plate 320 moves forward, the front surface of the shuttling plate 320 climbs over the curved portion of the support bracket 396. Thus, the opening and closing door 317 together with the support bracket 396 may rapidly exactly rotate forward.

One or more torsion springs are installed through a guide pin 398 installed at the lower portion of the assistant bracket 397. One side of the torsion spring is fixed to the assistant bracket 397 while the other side penetrates and is fixed to the support bracket 396. According to the rotation of the support bracket 396, the torsion spring is stretched or compressed so as to have elasticity.

An open and closed type induction heating part 350 is provided in the above-described second cooking space 302 of the cooking part 300 and may include guide rails 351, a shuttling plate 352, an induction cooking stand 360, transfer guides 357, a transfer connecting member 354, a driving motor 358, a crank member 356, and an opening and closing door 370.

The guide rail 351 is installed to face both facing lateral sides inside the above-described second cooking space 302, and both lateral sides of the shuttling plate 352 with a horizontal plane shape are slidably fitted into and coupled to the guide rails 351 such that the shuttling plate 352 comes in and out of the second cooking space 302.

The shuttling plate 352 has a mounting hole at the center of the upper surface thereof, and an instant food cooking container is placed through the mounting hole.

The mounting hole may have various sizes and shapes corresponding to an instant food cooking container such that the instant food cooking container is mounted onto the mounting hole.

An induction cooking stand 360 is installed at the lower portion of the shuttling plate 352, and includes a ceramic glass plate 361 and an induction coil 362.

The ceramic glass plate 361 is positioned at the lower portion of the shuttling plate 352, and the center of the ceramic glass plate 361 matches the center of the mounting hole.

The distance between the shuttling plate 352 and the ceramic glass plate 361 needs to be maintained at a certain height in the up-and-down direction. When an instant food cooking container is mounted onto the mounting hole of the shuttling plate 352, the bottom surface of the instant food cooking container needs to contact the ceramic glass plate 361.

An induction coil 362 is installed at the lower portion of the ceramic glass plate 361, and the induction coil 362 heats the instant food cooking container placed on the upper surface of the ceramic glass plate 361 by means of induction heating.

Herein, the instant food cooking container is provided with an induction heating body in various shapes such that induction heating is performed to contents such as the hot water, soup formation and solid ingredients inside the instant food cooking container through a magnetic field generated by the induction coil 362.

Meanwhile, a transfer connecting member 354 is installed at a certain distance from the shuttling plate at the rear of the shuttling plate 352, a long hole-shaped guide hole 355 penetrates and is formed at the upper surface of the transfer connecting member 354, and the transfer connecting member 354 and the shuttling plate 352 are connected by transfer guides 357 at which the transfer connecting member 354 and the shuttling plate 352 faces.

The shuttling plate 352 shuttles the inside and outside of the second cooing space 302. To this end, a driving motor 358 is installed at the rear of the second cooking space 302 through a bracket, the shaft of the driving motor 358 connects with a clutch member 390 while facing vertically downwards, one side of a crank member 356 connects with the bottom surface of the clutch member 390 while crossing the center of the lower surface of the clutch member, and the other side of the crank member 356 link-connects with the guide hole 355 at the upper surface of the above-described transfer connecting member 354.

Thus, when the driving motor 358 operates, one side of the crank member 356 rotates by means of the rotation of the clutch member 390. Accordingly, the transfer connecting member 354 link-connecting with the other side of the crank member 356 repeats moving forward and backward. According to the forward and backward movement of the transfer connecting member 354, the shuttling plate 352 moves forward and backward while being guided by the guide of the transfer guides 357.

Herein, in controlling a distance at which the shuttling plate 352 moves, as an example, limit switches positioned on the moving path of the shuttling plate 352 senses the movement of the shuttling plate 352, and a control part connecting with the limit switches determines the sensed movement so as to control the operation of the driving motor 358.

As another example, a disk 380 is installed at the upper portion of the clutch member 390 connecting with the driving motor 358 such that the shaft of the driving motor 358 penetrates the center of the clutch member 390, and a photo sensor 381 capable of recognizing the rotation of the disk 380 is installed together with the disk so as to sense the frequency of the rotation of the shaft of the driving motor 360, and then the control part may control the operation of the driving motor 358.

Herein, the driving motor 358 is driven, and then the shuttling plate 352 shuttles. In this case, if the shuttling plate 352 unintentionally stops, the driving motor 358 is overloaded. However, the driving motor 358 is prevented from being damaged through the slip of the clutch member 390.

An embodiment of the clutch member 390 includes a housing 391 to which the upper surface of one side of the crank member 356 is fixed so as to cross the center of the lower surface of the housing 391, and a cover 392 coupled to the upper portion of the housing 391. The end of the shaft of the driving motor 358, penetrating the upper surface of the cover 392, and one side of the crank member 356 are connected through a connecting member, a washer, and a plurality of plate sprigs. As a result, the rotational force of the driving motor 358 is usually delivered to the crank member 356. However, if the crank member 356 stops unnecessarily, the connecting member slips so as to prevent the rotational force of the driving motor 358 from being delivered to the crank member 356.

An opening and closing door 370 is installed at the front of the second cooking space 302 on the front surface of the body 100 such that the second cooking space 302 is opened and closed according to the forward and backward movement of the shuttling plate 352.

Both facing sides of the lower portion of the opening and closing door 370 are hinge-assembled to an assistant bracket 397 connecting with the body 100 together with a torsion spring. When the shuttling plate 352 moves toward the outside, the upper portion of the opening and closing door 370 rotates toward the front around the lower portion of the opening and closing door by means of external force according to the movement of the shuttling plate such that the second cooking space 302 is opened. In this case, when the torsion spring is stretched and has elasticity, and the shuttling plate 352 moves backwards, the external force applied to the opening and closing door 370 is removed, and the upper portion of the opening and closing door 370 rotates backwards around the lower portion of the opening and closing door by means of the resiliency of the torsion spring such that the second cooking space 302 is closed again.

A support bracket 396 supported by the torsion spring is installed inside the opening and closing door 370. A portion where the support bracket 396 contacts a protruding front surface of the shuttling plate 352 is configured to be curved and protrude toward the shuttling plate 352. When the shuttling plate 352 moves forward, the front surface of the shuttling plate 352 climbs over the curved portion of the support bracket 396. Thus, the opening and closing door 370 together with the support bracket 396 may rapidly exactly rotate forward.

One or more torsion springs are installed at a guide pin 398 installed in parallel with the assistant bracket 397. One side of the torsion spring is fixed to the assistant bracket 397 while the other side penetrates and is fixed to the support bracket 396. According to the rotation of the support bracket 396, the torsion spring is stretched or compressed so as to have elasticity.

Herein, described is one body 100 configured to cook instant food for steam cooking by using steam, and by hot water and an induction device such that in the case of instant food for steam cooking, a method of cooking using steam is applied to the above-described device for heating and cooking instant food, and in the case of instant food according to the present invention, a method of cooking with hot water and an induction device may also be applied to the above-described device for heating and cooking instant food together with the method of cooking using steam.

However, instant food according to an embodiment of the present invention is cooked with hot water and an induction device. A device for heating and cooking instant food may have a body 100 so as to cook instant food with hot water and an induction device or may have a plurality of bodies 100 so as to cook a plurality of instant foods.

A method of using the above-described device for heating and cooking instant food will be described as follows. First, a method of cooking using hot water and an induction device is applied to instant food according to the present invention. Thus, a method of cooking instant food for steam cooking with steam might be unnecessary. However, the case in which instant food for steam cooking is cooked by means of the above-described device for heating and cooking instant food will also be described for your reference.

When a container for cooking instant food for steam cooking, which will be cooked, is recognized through the operation of a display part provided at the front surface of a body 100, voice recognition, a camera, a sensor, and a code recognition device etc., a shuttling plate 320 moves forward and an opening and closing door 317 is rotated forward by the shuttling plate 320. Accordingly, a first cooking space 301 is opened, and the shuttling plate 320 is withdrawn outside the first cooking space 301 such that the container for cooking instant food for steam cooking is mounted.

Additionally, when the container for cooking instant food for steam cooking is mounted onto a steam cooking stand 330 of the withdrawn shuttling plate 320, the shuttling plate 320 is moved backward automatically, or manually through the manipulation of a display part etc., the opening and closing door 317 rotated forward returns to a place where it was, and then the first cooking space 301 is closed.

Then, a steam nozzle 250 moves down according to a set cooking manual. When a sharp part 251 penetrates the upper surface of the cover of the container for cooking instant food for steam cooking, spraying holes 252 of the sharp part 251 are positioned inside the container for cooking instant food for steam cooking. In this state, when steam passes the steam nozzle 250 and is sprayed through the spraying holes 252 for a certain period of time, contents inside the container for cooking instant food for steam cooking are cooked by the sprayed steam.

After cooking finishes, the shuttling plate 320 moves forward, the opening and closing door 317 is opened, the shuttling plate 320 is withdrawn outside the first cooking space 301, the container for cooking instant food for steam cooking is taken out of the steam cooking stand 330 of the withdrawn shuttling plate 320, the cover is removed, and then the cooked contents inside the container for cooking instant food for steam cooking are eaten.

Further, in the case in which instant food according to the present invention is cooked with hot water and an induction device, when an instant food cooking container for hot water heating, which will be cooked, is recognized through the operation of a display part provided at the front surface of a body 100, voice recognition, a camera, a sensor, and a code recognition device etc., a shuttling plate 352 moves forward and an opening and closing door 370 is rotated forward by the shuttling plate 352. Accordingly, a second cooking space 302 is opened, and the shuttling plate 320 is withdrawn outside the second cooking space 302 such that the instant food cooking container is mounted.

Additionally, when the instant food cooking container is mounted onto a mounting hole of the withdrawn shuttling plate 352, the shuttling plate 320 is moved backward automatically, or manually through the manipulation of a display part etc., the opening and closing door 370 rotated forward returns to a place where it was, and then the second cooking space 302 is closed.

Then a hot water nozzle 280 moves down according to a set cooking manual. When a sharp part 281 penetrates the upper surface of the cover of the instant food cooking container, discharging holes 282 of the sharp part 281 are positioned inside the instant food cooking container. In this state, steam passes the hot water nozzle 280 and is sprayed through the discharging holes 282 for a certain period of time.

Additionally, after the supply of hot water finishes, an induction coil 362 provided to an induction cooking stand 360 operates, an induction heating body provided to the instant food cooking container generates heat, hot water, a soup formation and solid ingredients inside the instant food cooking container are heated by the generated heat, and the contents inside the instant food cooking container may be cooked.

After cooking finishes, the shuttling plate 352 moves forward, the opening and closing door 370 is opened, the shuttling plate 352 is withdrawn outside the second cooking space 302, the instant food cooking container is taken out of the mounting hole of the withdrawn shuttling plate 352, the cover is removed, and then the cooked contents inside the instant food cooking container are eaten.

The specific embodiments of the present invention have been described in the detailed description of the invention. It should be understood that the present invention may be modified in various forms without departing from the scope of what has been described. Thus, the scope of what has been described should not be construed as being limited to the described embodiments. Rather, the present invention should be defined not only by the appended claims but by equivalents thereof.

### INDUSTRIAL APPLICABILITY

The present invention relates to a method for manufacturing instant food capable of being inductively cooked, a method for cooking the instant food, and a device for heating and cooking the instant food such that instant food can be simply and rapidly cooked through hot water and an induction device, can exhibit a uniform taste, and can be rich in nutrients thereby making it possible to improve a consumer's health.

1. A method for manufacturing instant food capable of being inductively cooked comprising:
a soup forming step of forming a soup for instant food into a plate-shaped soup formation;
a solid ingredient stacking step of putting a soup formation made through the soup forming step into an instant food cooking container and stacking instant food solid ingredients on the soup formation; and
a packaging step of sealing, by a cover, the open mouth of the instant food cooking container in which the solid ingredients are accommodated in a state of being stacked on the soup formation through the solid ingredient stacking step.

2. The method according to claim 1,
wherein a soup for instant food is frozen in a 4-mm to 5-mm-thick plate shape and formed into the soup formation.

3. The method according to claim 1, wherein the solid ingredients are configured to be 5 to 20 mm thick.

4. The method according to claim 1,
wherein the soup formation further comprises 1 to 3 parts by weight of lactic acid bacteria, and 3 to 5 parts by weight of roe with respect to 100 parts by weight of a soup formation.

5. The method according to claim 4,
wherein the lactic acid bacterium is Lactobacillus sporogenes.

6. The method according to claim 4,
wherein the roe is comprised of one or more selected from a group consisting of salmon roe, walleye pollock roe, flying fish roe, and herring roe.

7. A method for cooking instant food capable of being inductively cooked comprising:
an instant food positioning step of mounting, onto a device for heating and cooking instant food, an instant food cooking container in which a soup formation and solid ingredients are accommodated according to claim 1 with a cover on the instant food cooking container;
a hot water supplying step of making a hot water nozzle of the device for heating instant food penetrate the upper surface of the cover of the instant food cooking container mounted onto the device for heating and cooking instant food through the instant food positioning step, and supplying hot water supplied through the hot water nozzle into the instant food cooking container; and
an instant food heating step of heating the hot water, supplied into the instant food cooking container through the hot water supplying step, the soup formation and solid ingredients through the device for heating and cooking instant food.

8. A device for heating and cooking instant food capable of being inductively cooked, which heats and cooks a soup formation and solid ingredients, accommodated in an instant food cooking container, and hot water, according to the method of claim 1, comprising:
a body whose inner space is divided into the front and the rear by a vertical bracket, wherein the space of the front is divided into the upper portion and the lower portion by a horizontal partition plate installed on the front surface of the vertical bracket and configured to horizontally extend;
an electric outfitting part where a hot water generating part is installed at the upper portion of the front inside the body, and an electric outfitting part has a cool water storage tank installed at the rear inside the body; and
a cooking part where a second cooking space is formed at the lower portion of the front inside the body, and an open and closed type induction heating part is provided in the second cooking space.

9. The device according to claim 8,
wherein the hot water generating part comprising:
a guide frame installed at the upper surface of the horizontal partition plate;
a forward and reverse speed reduction motor installed at the upper surface of the guide frame;
a screw member installed and configured to extend downwards from the shaft of the forward and reverse speed reduction motor through a clutch member;
an ascending and descending plate coupled to a nut member joining the lower end of the screw member;
a hot water nozzle installed at one side of the ascending and descending plate and provided with a sharp part which has discharging holes at the lower end thereof extending vertically downwards; and
a solenoid valve whose one side connects with the hot water nozzle, whose other side connects with the cool water storage tank, and which connects with a hot water tank generating hot water so as to selectively supply hot water to the hot water nozzle.

10. The device according to claim 9,
wherein the clutch member comprises a housing in which the upper end of the screw member penetrates and is installed at the center of the lower surface of the housing, and a cover coupled to the opened upper surface of the housing,
the end of the shaft of the forward and reverse speed reduction motor, penetrating the upper surface of the cover, and the upper end of the screw member, penetrating the lower surface of the housing, are connected through a connecting member, a washer, and a plurality of plate sprigs so as to prevent the rotational force of the forward and reverse speed reduction motor from being delivered to the screw member when the forward and reverse speed reduction motor is overloaded.

11. The device according to claim 9,
wherein a disk is installed at the upper side of the clutch member such that the shaft of the forward and reverse speed reduction motor penetrates the center of the clutch member, and a photo sensor is installed at one side of the disk so as to sense the frequency of the rotation of the disk.

12. The device according to claim 8,
the open and closed type induction heating part comprising:
guide rails respectively installed on both sides of the inside of the second cooking space;
a shutting plate slidably coupled to the guide rails so as to come in and out of the second cooking space and having a mounting hole at the center of the upper surface thereof so as to mount an instant food cooking container to a certain depth;
an induction cooking stand comprising a ceramic glass plate installed on the lower side of the mounting hole of the shuttling plate, and an induction coil installed at the lower portion of the ceramic glass plate;
a plurality of transfer guides installed at the rear surface of the shuttling plate, configured to horizontally extend and configured to have a certain length;
a transfer connecting member connecting the ends of the transfer guides, paralleling the rear surface of the shuttling plate and having a guide hole with a long hole shape;
a driving motor installed at lower portion of the rear of the inside of the body;
a crank member which is parallelly installed on the upper side of the transfer connecting member, whose one end connects with the shaft of the driving motor through the clutch member and whose other end is link-coupled to the guide hole; and
an opening and closing door installed at the front of the second cooking space and configured to open and close the first cooking space according to the forward and backward movement of the shuttling plate.

13. The device according to claim 12,
wherein the clutch member comprises a housing to which the upper surface of one side of the crank member is fixed so as to cross the center of the bottom surface of the housing, and a cover coupled to the opened upper surface of the housing,
the end of the shaft of the driving motor, penetrating the upper surface of the cover, and the upper surface of the one side of the crank member, penetrating the lower surface of the housing, are connected through a connecting member, a washer, and a plurality of plate sprigs so as to prevent the rotational force of the driving motor from being delivered to the crank member when the driving motor is overloaded.

14. The method according to claim 2,
wherein the soup formation further comprises 1 to 3 parts by weight of lactic acid bacteria, and 3 to 5 parts by weight of roe with respect to 100 parts by weight of a soup formation.

15. A method for cooking instant food capable of being inductively cooked comprising:
an instant food positioning step of mounting, onto a device for heating and cooking instant food, an instant food cooking container in which a soup formation and solid ingredients are accommodated according to claim 2 with a cover on the instant food cooking container;
a hot water supplying step of making a hot water nozzle of the device for heating instant food penetrate the upper surface of the cover of the instant food cooking container mounted onto the device for heating and cooking instant food through the instant food positioning step, and supplying hot water supplied through the hot water nozzle into the instant food cooking container; and
an instant food heating step of heating the hot water, supplied into the instant food cooking container through the hot water supplying step, the soup formation and solid ingredients through the device for heating and cooking instant food.

16. A method for cooking instant food capable of being inductively cooked comprising:
an instant food positioning step of mounting, onto a device for heating and cooking instant food, an instant food cooking container in which a soup formation and solid ingredients are accommodated according to claim 3 with a cover on the instant food cooking container;
a hot water supplying step of making a hot water nozzle of the device for heating instant food penetrate the upper surface of the cover of the instant food cooking container mounted onto the device for heating and cooking instant food through the instant food positioning step, and supplying hot water supplied through the hot water nozzle into the instant food cooking container; and
an instant food heating step of heating the hot water, supplied into the instant food cooking container through the hot water supplying step, the soup formation and solid ingredients through the device for heating and cooking instant food.

17. A method for cooking instant food capable of being inductively cooked comprising:
an instant food positioning step of mounting, onto a device for heating and cooking instant food, an instant food cooking container in which a soup formation and solid ingredients are accommodated according to claim 4 with a cover on the instant food cooking container;
a hot water supplying step of making a hot water nozzle of the device for heating instant food penetrate the upper surface of the cover of the instant food cooking container mounted onto the device for heating and cooking instant food through the instant food positioning step, and supplying hot water supplied through the hot water nozzle into the instant food cooking container; and
an instant food heating step of heating the hot water, supplied into the instant food cooking container through the hot water supplying step, the soup formation and solid ingredients through the device for heating and cooking instant food.

18. A method for cooking instant food capable of being inductively cooked comprising:
an instant food positioning step of mounting, onto a device for heating and cooking instant food, an instant food cooking container in which a soup formation and solid ingredients are accommodated according to claim 5 with a cover on the instant food cooking container;
a hot water supplying step of making a hot water nozzle of the device for heating instant food penetrate the upper surface of the cover of the instant food cooking container mounted onto the device for heating and cooking instant food through the instant food positioning step, and supplying hot water supplied through the hot water nozzle into the instant food cooking container; and
an instant food heating step of heating the hot water, supplied into the instant food cooking container through the hot water supplying step, the soup formation and solid ingredients through the device for heating and cooking instant food.

19. A method for cooking instant food capable of being inductively cooked comprising:
an instant food positioning step of mounting, onto a device for heating and cooking instant food, an instant food cooking container in which a soup formation and solid ingredients are accommodated according to claim 6 with a cover on the instant food cooking container;
a hot water supplying step of making a hot water nozzle of the device for heating instant food penetrate the upper surface of the cover of the instant food cooking container mounted onto the device for heating and cooking instant food through the instant food positioning step, and supplying hot water supplied through the hot water nozzle into the instant food cooking container; and
an instant food heating step of heating the hot water, supplied into the instant food cooking container through the hot water supplying step, the soup formation and solid ingredients through the device for heating and cooking instant food.
